(19) United States
(12) Patent Application Publication
(10) Pub. No.: US 2022/0363053 A1
(43) Pub. Date: Nov. 17, 2022

(54) IMAGE FORMING APPARATUS

(71) Applicant: KYOCERA Document Solutions Inc., Osaka (JP)

(72) Inventors: Hironori DAIGO, Osaka-shi (JP); Hiroyuki TOMIOKA, Osaka-shi (JP)

(73) Assignee: KYOCERA Document Solutions Inc., Osaka (JP)

(21) Appl. No.: 17/737,367

(22) Filed: May 5, 2022

(30) Foreign Application Priority Data
May 11, 2021 (JP) 2021-080467

(51) Int. Cl. B41J 2/045

(52) U.S. Cl. CPC B41J 2/04563; B41J 2/04581

(57) ABSTRACT

An image forming apparatus includes a housing heater, recording heads, a head heater, a head temperature sensor and a controller. The housing heater heats an inside of a housing. The recording heads are stored in the housing and provided for colors of ink. The head heater is provided for each of the recording heads and heats the ink stored in each of the recording heads. The head temperature sensor detects a temperature of each of the recording heads. The controller drives the housing heater until a temperature of the ink estimated based on a detection result of the head temperature sensor reaches a printing permission temperature, and controls a driving of the head heater so as to maintain the printing permission temperature after the temperature of the ink reaches the printing permission temperature.

### INCORPORATION BY REFERENCE

This application is based on and claims the benefit of priority from Japanese patent application No. 2021-080467 filed on May 11, 2021, which is incorporated by reference in its entirety.

### BACKGROUND

The present disclosure relates to an inkjet type image forming apparatus including recording heads provided for respective colors of ink.

In an inkjet type image forming apparatus, various problems, such as color shift (printing position shift) and ink ejection failure, occur depending on a temperature in the apparatus main body.

For example, the color shift occurs as follows. The recording heads are generally arranged along the conveyance direction of the sheet conveyed by the conveyance belt. The ejection timing of the ink from each recording head is set based on the conveyance speed of the sheet within a predetermined temperature range. However, when the temperature in the apparatus main body is lower than the predetermined temperature range, because the head base holding the recording heads is contracted to shift the position of the recording head in the conveyance direction from the predetermined position, or the diameter of the drive roller or the driven roller around which the conveyance belt is wound is decreased to change the conveyance position of the sheet. As a result, the relative positional relationship between the recording heads and the sheet in the conveyance direction is changed with respect to the predetermined positional relationship. Then, the position of the ink ejected at a fixed ejection timing as described above shifts from the predetermined position in the conveyance direction, and the color shift (the printing position deviation) occurs. When the temperature of the ink is low, the ejection failure occurs because the ink has a high viscosity.

To solve the problem of the color shift, there is an image forming apparatus which detects an amount of change in an angular velocity of a rotating body (corresponding to the drive roller) and reduces the color shift in the conveyance direction. In addition, there is a printing apparatus (corresponding to an image forming apparatus) that corrects the color shift by comparing a printed test pattern with a printed image.

However, in the image forming apparatuses described above, the color shift and the ink ejection failure caused by the temperature are not considered.

### SUMMARY

In accordance with one aspect of the present disclosure, an image forming apparatus includes a housing heater, recording heads, a head heater, a head temperature sensor and a controller. The housing heater heats an inside of a housing. The recording heads are stored in the housing and provided for colors of ink. The head heater is provided for each of the recording heads and heats the ink stored in each of the recording heads. The head temperature sensor detects a temperature of each of the recording heads. The controller drives the housing heater until a temperature of the ink estimated based on a detection result of the head temperature sensor reaches a printing permission temperature, and controls a driving of the head heater so as to maintain the printing permission temperature after the temperature of the ink reaches the printing permission temperature.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an inner structure of an image forming apparatus according to one embodiment of the present disclosure.

FIG. 2 is a perspective view schematically showing a head unit, in the image forming apparatus according to the embodiment of the present disclosure.

FIG. 3A is a sectional view schematically showing a recording head, in the image forming apparatus according to the embodiment of the present disclosure.

FIG. 3B is a sectional view schematically showing an ejection unit of the recording head, in the image forming apparatus according to the embodiment of the present disclosure.

FIG. 4 is a block diagram showing a controller in the image forming apparatus according to the embodiment of the present disclosure.

FIG. 5 is a graph showing an example of a relationship between an amount of color shift and an elapsed time from when a power source is turned on.

FIG. 6 is a graph showing a relationship between a change in temperature of the recording head and an elapsed time from when the power source is turned on, in the image forming apparatus according to the embodiment of the present disclosure.

### DETAILED DESCRIPTION

Hereinafter, with reference to the attached drawings, an image forming apparatus according to one embodiment of the present disclosure will be described.

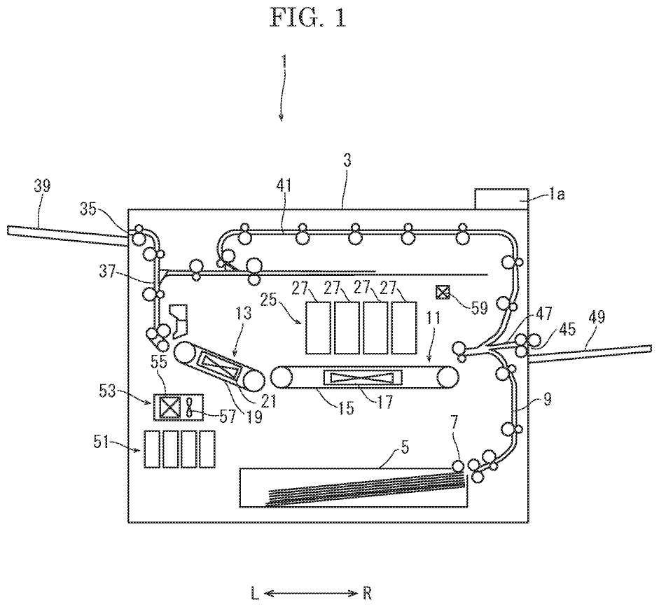

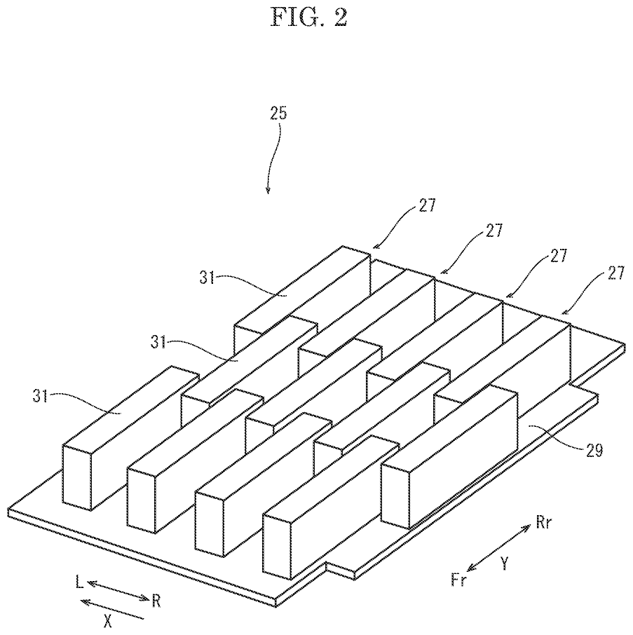

With reference to FIG. 1 and FIG. 2, the image forming apparatus 1 will be described. FIG. 1 is a front view schematically showing an inner structure of the image forming apparatus 1, and FIG. 2 is a perspective view showing a head unit 25. In each of the drawings, Fr, Rr, L, and R indicate the front, rear, left, and right sides of the image forming apparatus 1.

The image forming apparatus 1 includes a box-shaped housing 3. In the lower portion of the inside of the housing 3, a sheet feeding tray 5 on which a sheet is placed and a sheet feeding device 7 which feeds the sheet from the sheet feeding tray 5 and sends it to a first conveyance path 9 are stored. The first conveyance path 9 is formed in the right end portion of the inside of the housing 3 so as to extend upward from the sheet feeding device 7.

Above the sheet feeding tray 5, a first conveyance part 11 and a second conveyance part 13 are disposed side by side in the left-and-right direction. The first conveyance part 11 includes an endless first conveyance belt 15 wound between a driving roller and a driven roller, and a suction unit 17 disposed in the hollow space of the first conveyance belt 15. The first conveyance belt 15 travels in the counterclockwise direction of FIG. 1. The second conveyance part 13 includes an endless second conveyance belt 19 wound between a driving roller and a driven roller, and a suction unit 21 disposed in the hollow space of the second conveyance belt 19. The second conveyance belt 19 travels in the counterclockwise direction of FIG. 1. The sheet conveyed along the first conveyance path 9 is conveyed along the traveling direction while attracted to the upper traveling surface of the first conveyance belt 15 and the upper traveling surface of the second conveyance belt 19 by the respective suction units 17 and 21. In the following description, an upstream side and a downstream side indicate an upstream side and a downstream side in the sheet conveyance direction. Further, a direction perpendicular to the sheet conveyance direction is defined as a width direction.

Above the first conveyance part 11, a head unit 25 is provided. As shown in FIG. 2, the head unit 25 includes four line heads 27 corresponding to ink of four colors (yellow, magenta, cyan and black), and a base plate 29 on which the four line heads 27 are supported. The four line heads 27 are arranged in parallel along the sheet conveyance direction X (the left-and-right direction) and supported by the base plate 29.

Each line head 27 includes three recording heads 31. Each recording head 31 has a rectangular parallelepiped shape long in the width direction Y (the front-and-rear direction), and the three line heads 27 are arranged in a zigzag shape along the width direction Y. Each recording head 31 is provided with a number of nozzles arranged in the conveyance direction X and the width direction Y. The recording head 31 will be described later. Each recording head 31 ejects the ink downward from the nozzles to form an image on the sheet conveyed by the first conveyance belt 15.

With reference to FIG. 1 again, a second conveyance path 37 is provided between the downstream end of the second conveyance part 13 and a discharge port 35 formed on the left side surface of the housing 3. On the left side surface of the housing 3, a discharge tray 39 is supported below the discharge port 35. The sheet conveyed along the second conveyance path 37 is discharged from the discharge port 35 and stacked on the discharge tray 39.

The second conveyance path 37 branches to a third conveyance path 41 on the upstream side of the discharge port 35. The third conveyance path 41 includes a switchback path. The third conveyance path 41 merges with the first conveyance path 9 on the upstream side of the first conveyance part 11. A manual conveyance path 47 is formed between the merged portion of the first conveyance path 9 with the third conveyance path 41 and a manual sheet feeding port 45 formed on the right side surface of the housing 3. On the right side surface of the housing 3, a manual sheet feeding tray 49 is supported below the manual sheet feeding port 45.

Further, ink containers 51 for storing the inks of the four colors are provided in the housing 3. Each ink container 51 is connected to the corresponding line head 27 via a sub-ink tank (not shown). A housing heater 53 is provided near the ink containers 51. The housing heater 53 includes a ceramic heater 55 and a fan 57, and generates warm air blown toward the inside of the housing 3 to warm the inside of the housing 3. Further, a housing temperature sensor 59 is provided in the housing 3.

Next, a printing operation will be briefly described. The sheet fed from the sheet feeding tray 5 by the sheet feeding device 7 and conveyed along the first conveyance path 9 or the sheet fed from the manual sheet feeding tray 49 and conveyed through the manual sheet feeding port 45 along the manual conveyance path 47 is conveyed to the first conveyance part 11. In the first conveyance part 11, the sheet is attracted to the upper traveling surface of the first conveyance belt 15 by the suction unit 17 and is conveyed with the traveling of the first conveyance belt 15. At this time, the inks are ejected from the nozzles of the recording heads 31 of the line heads 27 of the head unit 25 to form an image on the sheet. The sheet on which the image is formed is conveyed to the second conveyance part 13. In the second conveyance part 13, the sheet is attracted to the upper traveling surface of the second conveyance belt 19 by the suction unit 21 and is conveyed with the traveling of the second conveyance belt 19. The sheet is conveyed from the second conveyance part 13 along the second conveyance path 37, discharged through the discharge port 35, and stacked on the discharge tray 39.

In the case of both-side printing, the sheet having the image formed on one surface is conveyed from the second conveyance path 37 to the third conveyance path 41. After the sheet is turned upside down while it is conveyed along the third conveyance path 41, the sheet is conveyed to the first conveyance part 11, the inks are ejected from the nozzles of the recording heads 31 of the line heads 27 of the head unit 25, and an image is formed on the other surface of the sheet. The sheet on which the images are formed is conveyed from the second conveyance part 13 along the second conveyance path 37, discharged through the discharge port 35, and stacked on the discharge tray 39.

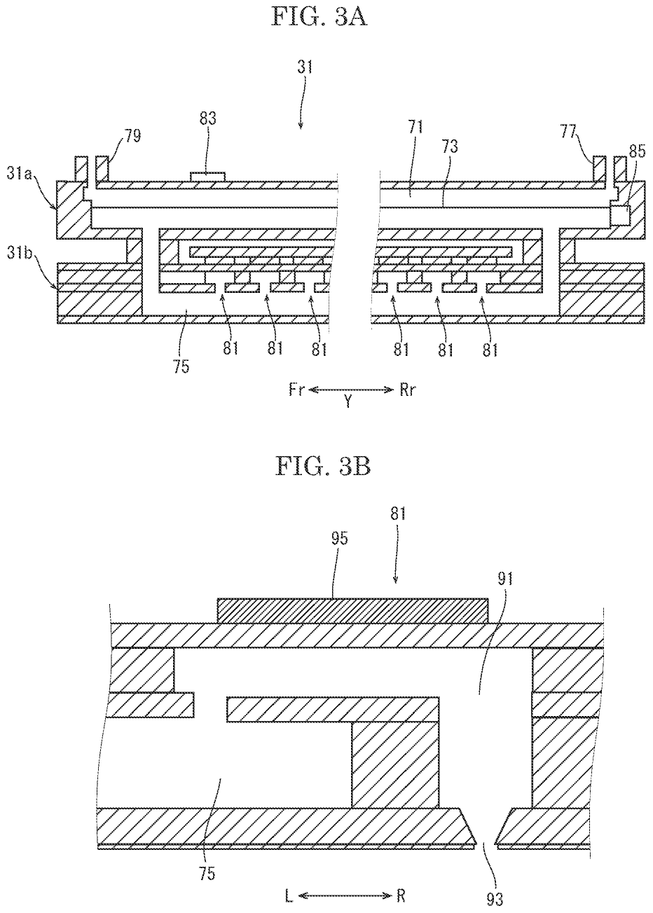

Next, the recording head 31 will be described with reference to FIG. 3A and FIG. 3B. FIG. 3A and FIG. 3B are sectional views showing the recording head 31.

As shown in FIG. 3A, the recording head 31 includes an ink storage part 31a formed along the width direction Y and an ink ejection part 31b disposed below the ink storage part 31a.

The ink storage part 31a has an ink reservoir 71. The ink reservoir 71 is divided into an upper section and a lower section by a filter 73. To the upper wall of the ink reservoir 71, an inlet tube 77 is connected at one end portion in the width direction Y, and an outlet tube 79 is connected at the other end portion. The tubes 77 and 79 communicate with the upper section of the ink reservoir 71. The ink supplied to the upper section of the ink reservoir through the inlet tube 77 is passed through the filter 73 and then supplied to the lower section. On the other hand, the ink not passed through filter 73 is discharged through the outlet tube 79.

A head temperature sensor 83 is provided on the upper wall of the ink storage part 31a. The head temperature sensor 83 measures a temperature of the upper wall of the ink storage part 31a. On the side wall of the ink storage part 31a, a head heater 85 is provided. The head heater 85 is a chip heater, for example, and heats the side wall so as to heat the ink in the ink reservoir 71.

The ink ejection part 31b has a common passage 75 communicated with the lower section of the ink reservoir 71 of the ink storage part 31a. In the common passage 75, a plurality of ejection units 81 is provided side by side in the width direction Y and the conveyance direction X.

As shown in FIG. 3B, each ejection unit 81 includes a pressurized room 91 communicated with the common passage 75 and a nozzle 93 opened downward from the pressurized room 91. An actuator 95 is provided in the pressurized room 91. The actuator 95 is a piezoelectric element, for example. When a voltage is applied to the piezoelectric element, the piezoelectric element is deformed by the reverse piezoelectric effect. The deformation of the piezoelectric element is transmitted to the pressurized room 91, and the pressurized room 91 is compressed. Thus, the ink supplied to the pressurized room 91 from the common passage 75 is pressurized and then ejected through the nozzle 93.

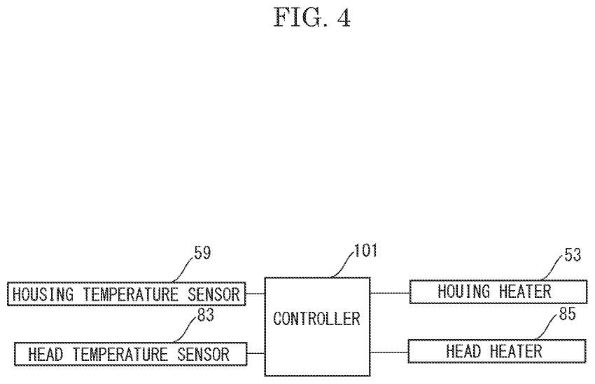

Next, the controller 101 will be described with reference to the block diagram shown in FIG. 4. To the controller 101, detection results are transmitted from the housing temperature sensor 59 (see FIG. 1) and the head temperature sensor 83 (see FIG. 3A). The controller 101 estimates a temperature of the inside of the housing 3 and a temperature of the ink in the line head 27 based on the detection results transmitted from both the temperature sensors 59 and 83. The controller 101 is electrically connected to the housing heater 53 and the head heater 85, and turns on or off (drives) the housing heater 53 and the head heater 85 based on the estimated temperatures of the inside of the housing 3 and the ink.

An example of temperature control of the image forming apparatus 1 having the above configuration will be described with reference to FIG. 1 to FIG. 3A. In a state in which the power source of the image forming apparatus 1 is turned off, when the power source is turned on, first, the controller 101 turns on the housing heater 53. When the housing heater 53 is turned on, the temperature of the inside of the housing 3 increases, and the temperatures of the housing 3 itself and the parts, such as the head unit 25, the driving rollers and the driven rollers of the first and second conveyance belts 15 and 19 of the first and second conveyance parts 11 and 13 described above, increase.

The controller 101 permits starting the printing operation after the temperature of ink estimated based on the detection result of the head temperature sensor 83 reaches a printing permission temperature (for example, 26° C.) in all recording heads 31. After the printing operation is started, the controller 101 turns on or off the head heater 85 based on the detection result of the head temperature sensor 83 to keep the temperature of the ink at the printing permission temperature. Further, the controller 101 turns on or off the housing heater 53 based on the detection result of the housing temperature sensor 59 to keep the temperature of the inside of the housing 3 constant.

As shown in FIG. 1, the head unit 25 is relatively far away from the housing heater 53, and the ink reservoir 71 (see FIG. 3A) of the recording head 31 in which the ink used for the printing operation is stored is provided inside the recording head 31. Therefore, the temperature of the ink stored in the ink reservoir 71, that is, the ink used for the printing operation, is less likely to be increased than the other portions. Thereby, when the temperature of the inside of the housing 3 is lower than a predetermined temperature, the color shift (the printing position shift) is likely to occur, as described above.

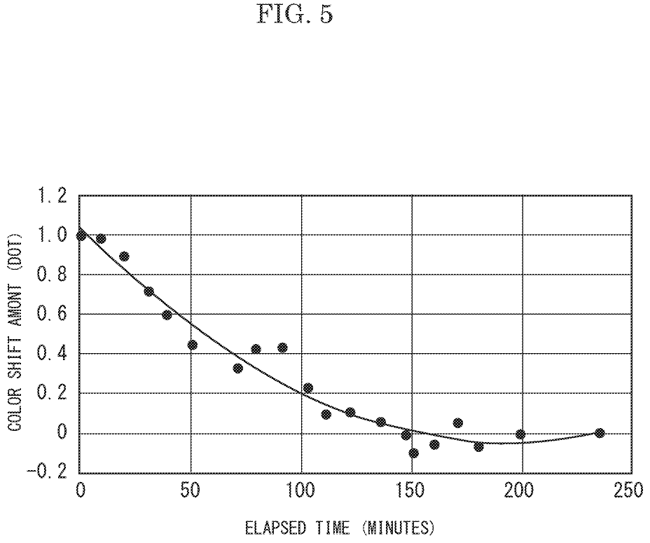

An example of the color shift will be described with reference to the graph shown in FIG. 5. The vertical axis of the graph indicates an amount of a color shift (dots), and the horizontal axis indicates an elapsed time (minutes) from when the power source is turned on (the housing heater 53 is turned on). In this example, a case where the ambient temperature is a low temperature (15° C.) lower than the reference temperature (20 to 23° C.) will be described.

As shown in the graph, immediately after the power source is turned on, the color shift amount is about 1 dot, and the color shift amount is large. The color shift amount gradually decreases as the elapsed time increases, and becomes almost zero (0) after about 150 minutes elapses.

That is, it is understood that when the housing heater 53 is turned on, the temperature in the inside of the housing 3 increases, and the temperature of the housing 3 itself and the parts, such as the head unit 25, the drive rollers and driven rollers of the first and second conveyance belts 15 and 19 of the first and second conveyance parts 11 and 13, gradually increases, but a predetermined time (150 minutes in this example) is required until the color shift amount becomes zero, that is, until the temperature of the ink reaches the appropriate printing permission temperature. In order to prevent the color shift, it is necessary to start the printing operation after the entire image forming apparatus 1 (including the respective parts and the inks) has reached the uniform printing permission temperature.

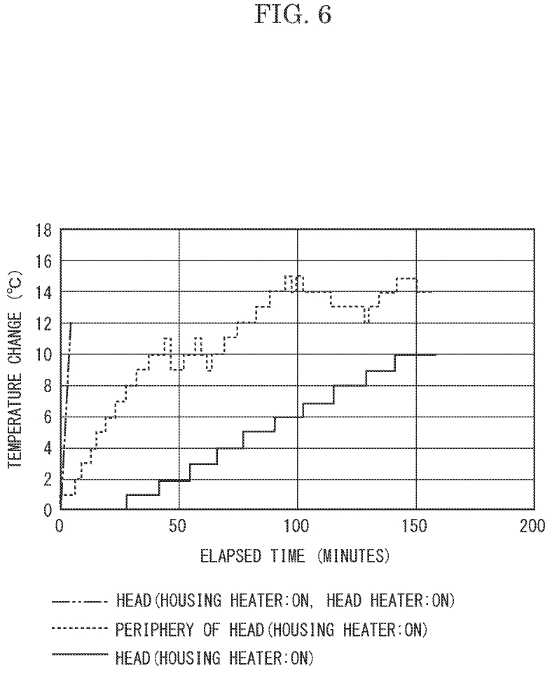

Next, with reference to the graph shown in FIG. 6, a temperature increasing tendency of each part of the image forming apparatus 1 will be described. The vertical axis of the graph indicates a temperature change (° C.), and the horizontal axis indicates an elapsed time (minutes). The two-dot chain of the graph shows the detection result of the head temperature sensor 83 when the housing heater 53 and the head heater 85 are turned on at the same time as the power source is turned on, the chain line shows the detection result of a temperature sensor (not shown) disposed around the recording head 31 when the housing heater 53 is turned on at the same time as the power source is turned on, and the solid line shows the detection result of the head temperature sensor 83 when the housing heater 53 is turned on at the same time as the power source is turned on. The ambient temperature is 14° C.

As shown by the two-dot chain line of the graph, when the housing heater 53 and the head heater 85 are turned on at the same time as the power source is turned on, the temperature detected by the head temperature sensor 83 increases rapidly, and after about three (3) minutes, the temperature increases by 12° C. to almost reach the printing permission temperature. When the head heater 85 is turned on in this way, the temperature of the recording head 31 rapidly increases to reach the printing permission temperature, but as described above with reference to the graph shown in FIG. 5, the parts provided inside the housing 3 are not sufficiently heated and their temperatures do not reach the printing permission temperature. Therefore, if the printing operation is performed under this condition, there is a possibility that the color shift occurs.

Further, as shown by the chain line of the graph, when the housing heater 53 is turned on at the same time as the power source is turned on, the temperature of the periphery around the recording head 31 increases, but the increasing degree is not uniform, and the variation amount of the temperature is large. Therefore, for example, if the starting of the printing operation is determined based on the temperature of the periphery around the recording head 31, the printing operation may be performed while the entire image forming apparatus 1 (including the respective parts and the inks) does not always reach the uniform printing permission temperature.

On the other hand, as shown by the solid line of the graph, when the housing heater 53 is turned on at the same time as the power source is turned on, the temperature detected by the head temperature sensor 83 gradually increases at a substantially uniform degree and the variation amount of the temperature is small. That is, the temperature increasing around the ink reservoir 71 of the recording head 31 starts later than that of the periphery, in other words, the ink reservoir 71 is less likely to be heated, but is less susceptible to the influence of the external environment, and the temperature of the ink reservoir 71 increases in proportion to the temperature increasing by the housing heater 53. In addition, when the temperature of the portion where is difficult to be heated is increased to the print permission temperature, it can be estimated that the entire inside of the housing has almost reached the print permission temperature. Therefore, it is preferable to determine that the entire image forming apparatus 1 (including the respective parts and the inks) has reached the uniform printing permission temperature based on the detection result of the head temperature sensor 83 and then to perform the printing operation.

After the printing operation is started, the controller 101 turns on or off the housing heater 53 based on the detection result of the housing temperature sensor 59 to maintain the temperature of the inside of the housing 3 at the predetermined temperature. On the other hand, the controller 101 turns on or off the head heater 85 based on the detection result of the head temperature sensor 83 to maintain the temperature of the ink at the predetermined temperature. As shown by the two-dot chain line of the graph shown in FIG. 6, since the ink has a high sensitivity to the head heater 85, the temperature of the ink can be adjusted with a high sensitivity.

As described above, according to the present disclosure, in the case of a low temperature environment, the printing operation is started after the temperature of the inside of the housing (including the temperature of the ink of each recording head 31) uniformly increases to the printing permission temperature, so that the occurrence of the color shift can be reduced. Further, since the temperature of each recording head 31 is adjusted by turning on and off the head heater 85 after the temperature is increased to the printing permission temperature, the temperature of the ink can be adjusted with a high sensitivity.

As described with reference to the graph shown in FIG. 5, it requires a predetermined time (150 minutes in the above example) to increase the temperature of the inside of the housing until no color shift occurs. However, a user may wish to start the printing operation before the predetermined time has elapsed. Therefore, the controller 101 may permit the printing operation regardless of the temperature of the ink. In this case, the operation part 1a (see FIG. 1) of the image forming apparatus 1 is provided with a printing priority mode for permitting the printing operation regardless of the temperature of the ink, and when the printing priority mode is selected, a message indicating that print quality is not guaranteed is displayed on the operation part 1a. When the user selects the printing priority mode, the controller 101 permits the printing operation regardless of the detection result of the head temperature sensor 83.

Although the disclosure has been described with respect to specific embodiments, the disclosure is not limited to the above embodiments. Those skilled in the art may modify the embodiments described above without departing from the scope and spirit of the invention.

1. An image forming apparatus comprising:
a housing heater heating an inside of a housing;
recording heads stored in the housing and provided for colors of ink;
a head heater provided for each of the recording heads and heating the ink stored in each of the recording heads;
a head temperature sensor detecting a temperature of each of the recording heads; and
a controller which drives the housing heater until a temperature of the ink estimated based on a detection result of the head temperature sensor reaches a printing permission temperature, and controls a driving of the head heater so as to maintain the printing permission temperature after the temperature of the ink reaches the printing permission temperature.

2. The image forming apparatus according to claim 1, wherein,
the controller starts a printing operation after each of the inks reaches the printing permission temperature.

3. The image forming apparatus according to claim 2, further comprising:
a housing temperature sensor for detecting a temperature of the inside of the housing, wherein
after starting the printing operation, the controller controls the housing heater based on a detection result of the housing temperature sensor to maintain the temperature of the inside the housing at a predetermined temperature.

4. The image forming apparatus according to claim 1, wherein,
the recording head has an ink reservoir, and
the temperature sensor is provided on an upper wall of the ink reservoir.

5. The image forming apparatus according to claim 1, further comprising:
an operation part capable of allowing a user to select a printing priority mode for permitting a printing operation even when the temperature of the ink does not reach the printing permission temperature, wherein
when the print priority mode is selected, a message indicating that print quality is not guaranteed is displayed on the operation part.
